(19) United States
(12) Patent Application Publication
(10) Pub. No.: US 2026/0142584 A1
(43) Pub. Date: May 21, 2026

(54) POWER CONVERSION DEVICE

(71) Applicant: TOYOTA JIDOSHA KABUSHIKI KAISHA, Toyota-shi (JP)

(72) Inventor: Atsushi HAYASHI, Susono-shi (JP)

(73) Assignee: TOYOTA JIDOSHA KABUSHIKI KAISHA, Toyota-shi (JP)

(21) Appl. No.: 19/335,422

(22) Filed: Sep. 22, 2025

(30) Foreign Application Priority Data
Nov. 21, 2024 (JP) 2024-203407

(51) Int. Cl. H02M 7/00

(52) U.S. Cl. CPC H02M 7/003

(57) ABSTRACT

A power conversion device includes a capacitor including a first terminal electrode and a second terminal electrode opposed to the first terminal electrode, a power module including a power semiconductor element, a terminal block for electrically connecting the capacitor and the power module to each other, a first bus bar connecting the first terminal electrode and the terminal block, a second bus bar connecting the second terminal electrode and the terminal block, and a plate member on which the capacitor, the power module, and the terminal block are mounted, the plate member including a flow path for a cooling medium that cools the capacitor and the terminal block.

### CROSS-REFERENCE TO RELATED APPLICATION

This application is based upon and claims the benefit of priority of the prior Japanese Patent Application No. 2024-203407, filed on Nov. 21, 2024, the entire contents of which are incorporated herein by reference.

### TECHNICAL FIELD

The present disclosure relates to a power conversion device.

### BACKGROUND

Regarding a power conversion device, for example, Japanese Unexamined Patent Application Publication No. 2017-139886 describes that a capacitor including a pair of end surface electrodes facing each other and a semiconductor module connected to the capacitor by a bus bar are placed on a cooler. The capacitor is mounted on the cooler with one end surface electrode facing the cooler and the other end surface electrode facing the side opposite to the cooler.

In the capacitor, a region near the end surface electrode on the side opposite to the cooler is farther from the cooler than a region near the end surface electrode on the cooler side, and thus a sufficient cooling effect might not be obtained.

### SUMMARY

The present disclosure has been made in view of the above problem, and an object of the present disclosure is to provide a power module and a power conversion device capable of improving cooling effect of a capacitor.

A power conversion device according to the present disclosure includes: a capacitor including a first terminal electrode and a second terminal electrode opposed to the first terminal electrode; a power module including a power semiconductor element; a terminal block for electrically connecting the capacitor and the power module to each other; a first bus bar connecting the first terminal electrode and the terminal block; a second bus bar connecting the second terminal electrode and the terminal block; and a plate member on which the capacitor, the power module, and the terminal block are mounted, the plate member including a flow path for a cooling medium that cools the capacitor and the terminal block, wherein the capacitor is mounted on the plate member with the first terminal electrode facing the flow path and the second terminal electrode facing a side opposite to the flow path, and the terminal block includes: a first connection portion connected to the first bus bar; and a second connection portion connected to the second bus bar, thermal conductivity between the capacitor and the flow path in the second connection portion is higher than thermal conductivity between the capacitor and the flow path in the first connection portion.

In the above power conversion device, a connection position of the second connection portion and the second bus bar may be closer to the flow path than a connection position of the first connection portion and the first bus bar is.

In the above power conversion device, a first nut to which the first bus bar is fastened by a bolt may be embedded in the first connection portion such that an end surface of the first nut faces the flow path in an axial direction of the first nut, and a second nut to which the second bus bar is fastened by a bolt may be embedded in the second connection portion such that an end surface of the second nut faces the flow path in an axial direction of the second nut, and an area of the end surface of the second nut may be larger than an area of the end surface of the first nut.

In the above power conversion device, a first nut to which the first bus bar is fastened by a bolt may be embedded in the first connection portion such that an end surface of the first nut faces the flow path in an axial direction of the first nut, a second nut to which the second bus bar is fastened by a bolt may be embedded in the second connection portion such that an end surface of the second nut faces the flow path in an axial direction of the second nut, and thermal conductivity of the second nut may be higher than thermal conductivity of the first nut.

In the above power conversion device, a first nut to which the first bus bar is fastened by a bolt may be embedded in the first connection portion with an end surface of the first nut facing the flow path in an axial direction of the first nut, a first sheet member may be provided between the end surface of the first nut and a plate surface of the plate member, a second nut to which the second bus bar is fastened by a bolt may be embedded in the second connection portion with an end surface of the second nut facing the flow path in an axial direction of the second nut, a second sheet member may be provided between the end surface of the second nut and a plate surface of the plate member, and thermal conductivity of the second sheet member may be higher than thermal conductivity of the first sheet member.

### BRIEF DESCRIPTION OF THE DRAWINGS

FIG. 1 is a plan view illustrating an example of a power conversion device in a top view;

FIG. 2 is a diagram schematically illustrating a circuit configuration of the power conversion device;

FIG. 3 is a partial cross-sectional view taken along line A-A of FIG. 1;

FIG. 4 is a plan view illustrating an example of a flow path of cooling water in a top view;

FIG. 5 is a partial cross-sectional view taken along line B-B of FIG. 1; and

FIG. 6A is a partial cross-sectional view taken along line C-C of FIG. 1, and FIG. 6B is a plan view illustrating an example of a lower surface of a terminal block in a front view.

### DETAILED DESCRIPTION

### (Configuration of Power Conversion Device)

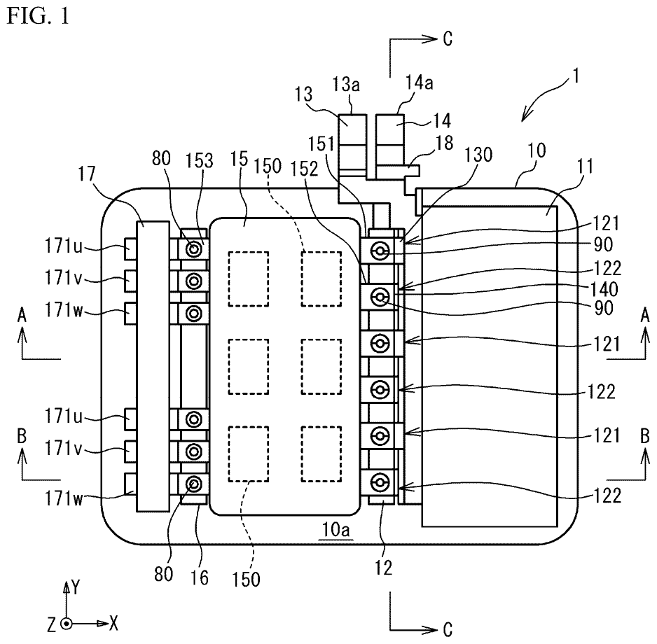

FIG. 1 is a plan view illustrating an example of a power conversion device 1 in a top view. In FIG. 1 and the subsequent drawings, an X direction, a Y direction, and a Z direction orthogonal to one another are illustrated.

The power conversion device 1 includes a frame 10, a film capacitor 11, terminal blocks 12 and 16, a negative-terminal-side bus bar 13, a positive-terminal-side bus bar 14, a power module 15, and a terminal holding portion 17. The power conversion device 1 is used as, for example, a power control unit of an electric vehicle or a hybrid vehicle. Note that an upper cover, a control board, a noise filter, a harness, and the like of the power conversion device 1 are not illustrated.

The frame 10 is a substantially rectangular plate member. The film capacitor 11, the terminal blocks 12 and 16, the power module 15, and the terminal holding portion 17 are mounted on a plate surface 10a of the frame 10. A flow path for cooling water described later is provided inside the frame 10. Thus, the frame 10 cools the film capacitor 11, the terminal blocks 12 and 16, the power module 15, and the terminal holding portion 17.

The frame 10 is made of a metal having high rigidity and high thermal conductivity.

The film capacitor 11 is an example of a capacitor. The film capacitor 11 has a positive terminal electrode and a negative terminal electrode connected to the positive-terminal-side bus bar 14 and the negative-terminal-side bus bar 13, respectively. An end portion 14a of the positive-terminal-side bus bar 14 and an end portion 13a of the negative-terminal-side bus bar 13 are disposed outside an end portion of the frame 10 on the positive side in the Y direction, and are electrically connected to a positive electrode and a negative electrode of an external battery (not illustrated), respectively. The positive-terminal-side bus bar 14 and the negative-terminal-side bus bar 13 are made of a metal having high conductivity such as copper.

An insulating member 18 for preventing a short circuit is held between the positive-terminal-side bus bar 14 and the negative-terminal-side bus bar 13. The positive-terminal-side bus bar 14 is disposed on the positive side (upper portion) of the negative-terminal-side bus bar 13 in the Z direction with the insulating member 18 interposed therebetween. The positive-terminal-side bus bar 14 and the negative-terminal-side bus bar 13 are bent from the end portions 14a and 13a, respectively, in the positive X direction, and extend from the bent portions in the negative Y direction between the power module 15 and the film capacitor 11. Each of the portions of the positive-terminal-side bus bar 14 and the negative-terminal-side bus bar 13 extending in the Y direction branch toward the terminal electrodes of the film capacitor 11 in the positive X direction and the terminal block 12 in the negative X direction.

The power module 15 incorporates one or more power semiconductor elements 150. The power semiconductor element 150 is, for example, an intelligent power module (IPM). The IPM includes a switch element such as an insulated gate bipolar transistor (IGBT), a freewheeling diode connected in parallel to the switch element, and the like. In this example, the six power semiconductor elements 150 function as an inverter that performs power conversion. The power module 15 is electrically connected to the positive-terminal-side bus bar 14 and the negative-terminal-side bus bar 13 at the terminal block 12, and is electrically connected to the connection terminals 171u, 171v, and 171w at the terminal block 16.

The terminal holding portion 17 holds two sets of connection terminals 171u, 171v, and 171w each having a rectangular flat plate shape on the upper portion of the frame 10. The connection terminals 171u, 171v, and 171w are connected to an external motor (not illustrated) and extend in parallel from the end portion of the frame 10 on the negative side in the X direction to the terminal block 16. On the other hand, the power module 15 has six terminals 153 extending to the terminal block 16. The terminals 153 are connected to the connection terminals 171u, 171v, and 171w, respectively, by bolts 80 on the terminal block 16.

The power module 15 includes three pairs of positive terminals 152 and negative terminals 151 that extend to the terminal block 12 on the opposite side of the terminal block 16 in the X direction. The positive terminals 152 and the negative terminals 151 are alternately arranged in the Y direction. The terminal block 12 includes three sets of positive-terminal-side connection portions 122 and negative-terminal-side connection portions 121. The positive-terminal-side connection portions 122 and the negative-terminal-side connection portions 121 are alternately arranged in the Y direction. The positive-terminal-side connection portion 122 is connected to the positive-terminal-side bus bar 14, and the negative-terminal-side connection portion 121 is connected to the negative-terminal-side bus bar 13. The positive-terminal-side connection portion 122 is an example of a first connection portion, and the negative-terminal-side connection portion 121 is an example of a second connection portion.

Each of the positive-terminal-side bus bar 14 and the negative-terminal-side bus bar 13 is branched in two directions, that is, toward the terminal block 12 and toward the film capacitor 11. The positive-terminal-side bus bar 14 and the negative-terminal-side bus bar 13 each have three connection terminals 140 and 130 extending to the terminal block 12. The connection terminal 140 and the positive terminal 152 are fastened to the positive-terminal-side connection portion 122 by bolts 90. The connection terminal 130 and the negative terminal 151 are fastened to the negative-terminal-side connection portion 121 by the bolts 90. In this way, the terminal block 12 is used to electrically connect the film capacitor 11 and the power module 15 to each other.

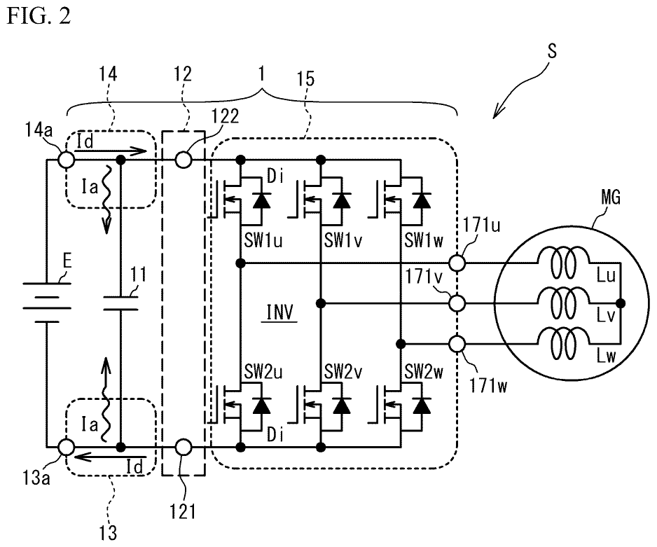

FIG. 2 is a diagram schematically illustrating a circuit configuration S of the power conversion device 1. The power conversion device 1 is connected between a battery E such as a lithium ion battery and a motor MG. The motor MG is used as, for example, a drive source of the vehicle. The end portion 14a of the positive-terminal-side bus bar 14 is connected to a positive electrode of the battery E. The end portion 13a of the negative-terminal-side bus bar 13 is connected to a negative electrode of the battery E. The connection terminals 171u, 171v, and 171w are connected to three phase coils Lu, Lv, and Lw of the motor MG, respectively.

The power module 15 includes an inverter INV. The inverter INV is connected in parallel to the film capacitor 11 and the battery E via the positive-terminal-side connection portions 122 and the negative-terminal-side connection portions 121 of the terminal block 12. The inverters INV include upper arm side switch elements SW1u, SW1v, and SW1w and lower arm side switch elements SW2u, SW2v, and SW2w corresponding to the three phases. The switch elements SW1u, SW1v, and SW1w on the upper arm side and the switch elements SW2u, SW2v, and SW2w on the arm side are connected in series, respectively. A rectifier diode Di is connected to each of the switch elements SW1u, SW1v, SW1w, SW2u, SW2v, and SW2w. The switch elements SW1u, SW1v, SW1w, SW2u, SW2v, and SW2w and the rectifier diodes Di are included in the power semiconductor element 150.

The switch elements SW1u, SW1v, SW1w, SW2u, SW2v, and SW2w are controlled to be turned on and off by a pulse width modulation (PWM) signal from a control board (not illustrated). Thus, the direct current input from the battery E to the inverter INV is converted into three phase alternating current and output to the motor MG.

The film capacitor 11 is connected in parallel to the battery E and the inverter INV. The positive-terminal-side bus bar 14 connects the positive electrode of the battery E, the positive terminal electrode of the film capacitor 11, and the positive-terminal-side connection portions 122 of the terminal block 12. The negative-terminal-side bus bar 13 connects the negative electrode of the battery E, the negative terminal electrode of the film capacitor 11, and the negative-terminal-side connection portions 121 of the terminal block 12. In the positive-terminal-side bus bar 14 and the negative-terminal-side bus bar 13, a DC component Id of a current flows between the battery E and the inverter INV. A ripple component Ia of the current flows through both terminal electrodes of the film capacitor 11. The film capacitor 11 smooths the voltage across the inverter INV.

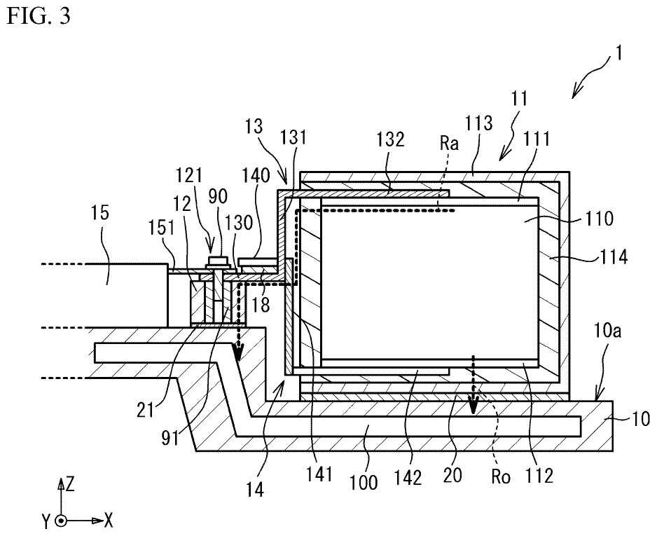

FIG. 3 is a partial cross-sectional view taken along line A-A of FIG. 1. In FIG. 3, the same reference numerals are given to the same components as those in FIG. 1, and the description thereof will be omitted. A flow path 100 for cooling water is provided along the plate surface 10a inside the frame 10. The film capacitor 11 includes a capacitor element 110, a positive-terminal-side terminal electrode 112, a negative-terminal-side terminal electrode 111, and a case 113. The plate surface 10a of the frame 10 has a step so that the mounting position of the film capacitor 11 in the Z direction is lower than the mounting positions of the terminal block 12 and the power module 15.

The capacitor element 110 is formed by winding a resin film on which aluminum is evaporated. The positive-terminal-side terminal electrode 112 and the negative-terminal-side terminal electrode 111 are end surface electrodes called metallicon or the like. In the Z direction, the negative-terminal-side terminal electrode 111 is provided on the upper surface of the capacitor element 110, and the positive-terminal-side terminal electrode 112 is provided on the lower surface of the capacitor element 110. The positive-terminal-side terminal electrode 112 and the negative-terminal-side terminal electrode 111 face each other in the Z direction with the capacitor element 110 interposed therebetween.

In this way, the film capacitor 11 is mounted on the frame 10 with the positive-terminal-side terminal electrode 112 facing the flow path 100 for the cooling water and the negative-terminal-side terminal electrode 111 facing the opposite side of the flow path 100. The positive-terminal-side terminal electrode 112 is an example of a first terminal electrode, and the negative-terminal-side terminal electrode 111 is an example of a second terminal electrode. In addition, contrary to the present example, the film capacitor 11 may be mounted on the frame 10 with the negative-terminal-side terminal electrode 111 facing the flow path 100 and the positive-terminal-side terminal electrode 112 facing the opposite side. In this case, the positive-terminal-side terminal electrode 112 corresponds to the second terminal electrode. The negative-terminal-side terminal electrode 111 corresponds to the first terminal electrode. The positive-terminal-side connection portion 122 corresponds to a second connection portion. The negative-terminal-side connection portion 121 corresponds to a first connection portion.

The case 113 has a substantially rectangular parallelepiped box shape with a surface on the terminal block 12 side opened. A resin 114 called a potting material is filled between the case 113 and the capacitor element 110. The case 113 is formed of, for example, a resin, a metal such as aluminum, or a resin coated with aluminum.

A silicone sheet 20 is provided between the lower portion of the case 113 and the plate surface 10a of the frame 10. The silicone sheet 20 diffuses heat of the capacitor element 110 to the plate surface 10a of the frame 10. Therefore, the film condenser 11 is cooled by the cooling water through the silicone sheet 20.

A silicone sheet 21 is provided between the negative electrode side connection portion 121 and the plate surface 10a of the frame 10. The silicone sheet 21 diffuses heat of the negative electrode side connection portion 121 to the plate surface 10a of the frame 10. The temperature of the terminal block 12 rises due to not only the DC component of the current flowing through the positive-terminal-side bus bar 14 and the negative-terminal-side bus bar 13 but also the heat conducted from the film capacitor 11 via the positive-terminal-side bus bar 14 and the negative-terminal-side bus bar 13. The heat of the negative-terminal-side connection portion 121 of the terminal block 12 is cooled by the cooling water in the flow path 100 via the silicone sheet 21. The cooling water is an example of a cooling medium, and another fluid may be used as the cooling medium.

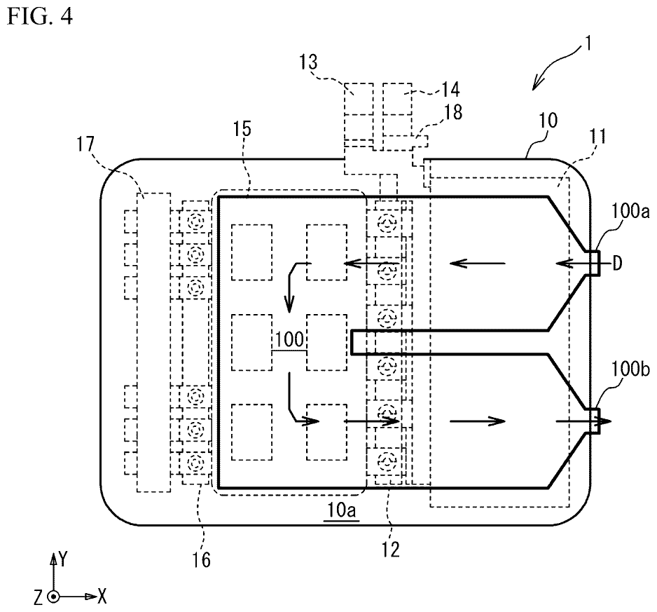

FIG. 4 is a plan view illustrating an example of the flow path 100 of the cooling water in a top view. In FIG. 4, the same reference numerals are given to the same components as those in FIG. 1, and the description thereof will be omitted.

The flow path 100 has a substantially U-shape so as to pass through the film capacitor 11, the terminal block 12, and the lower portion of the power module 15. Reference sign D indicates a direction in which the cooling water flows. An inlet 100a and an outlet 100b of the flow path 100 are provided side by side on an end surface of the frame 10 on the positive side in the X direction. The inlet 100a and the outlet 100b are connected to an external pump or the like.

Referring again to FIG. 3, the negative-terminal-side bus bar 13 includes a connection terminal 130, an extension portion 131, and an electrode connection portion 132. The connection terminal 130 extends from the lower end, in the Z direction, of the extension portion 131 to the negative X direction, and is fastened to the negative-terminal-side connection portion 121 of the terminal block 12 by the bolt 90 together with the negative terminal 151 of the power module 15. Each of nuts 91 is embedded in the negative-terminal-side connection portion 121 along the Z direction. The bolt 90 is screwed into the nut 91, and thus the connection terminal 130 and the negative terminal 151 are fixed to the negative-terminal-side connection portion 121 of the terminal block 12 in an overlapping manner.

The extension portion 131 is a plate-shaped member extending in the positive Y direction, and is held in a posture in which the plate surface thereof is substantially orthogonal to the plate surface 10a of the frame 10. The lower end of the extension portion 131 in the Z direction is connected to the connection terminal 130, and the upper end of the extension portion 131 in the Z direction is connected to the electrode connection portion 132. The electrode connection portion 132 extends from the upper end, in the Z direction, of the extension portion 131 in the positive X direction and is connected to the negative-terminal-side terminal electrode 111 in the Z direction. In this way, the negative-terminal-side bus bar 13 connects the negative electrode side terminal electrode 111 and the terminal block 12.

A part of the heat of the film capacitor 11 is cooled by the cooling water via the silicone sheet 20 as indicated by reference numeral Ro, and another part of the heat of the film capacitor 11 is cooled by the cooling water via a cooling path Ra passing through the negative-terminal-side bus bar 13. The cooling path Ra extends from the negative-terminal-side terminal electrode 111 to the negative-terminal-side connection portion 121 of the terminal block 12 via the negative-terminal-side bus bar 13. The heat of the film capacitor 11 is conducted through the cooling path Ra and diffused from the nut 91 in the negative-terminal-side connection portion 121 to the flow path 100 in the frame 10 via the silicone sheet 21.

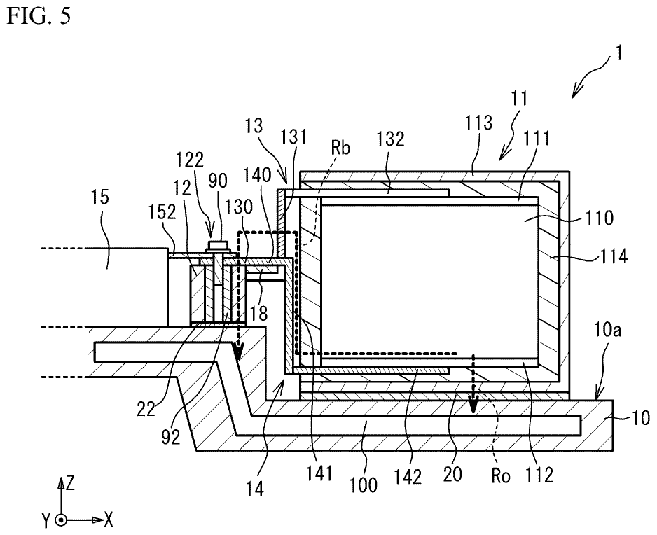

FIG. 5 is a partial cross-sectional view taken along line B-B of FIG. 1. In FIG. 5, the same reference numerals are given to the same components as those in FIG. 1, and the description thereof will be omitted.

A silicone sheet 22 is provided between the positive-terminal-side connection portion 122 and the plate surface 10a of the frame 10. The silicone sheet 22 diffuses heat of the positive-terminal-side connection portion 122 to the plate surface 10a of the frame 10.

The positive-terminal-side bus bar 14 includes the connection terminal 140, an extension portion 141, and an electrode connection portion 142. The connection terminal 140 extends from the upper end, in the Z direction, of the extension portion 141 in negative X direction, and is fastened to the positive-terminal-side connection portion 122 of the terminal block 12 by the bolts 90 together with the positive terminal 152 on the power module 15. Each of nuts 92 is embedded in the positive-terminal-side connection portion 122 along the Z direction. The bolt 90 is screwed into the nut 92, and thus the connection terminal 140 and the positive terminal 152 are fixed to the positive-terminal-side connection portion 122 of the terminal block 12 in an overlapping manner.

The extension portion 141 is a plate-shaped member extending in the Y direction, and is held in a posture in which the plate surface is substantially orthogonal to the plate surface 10a of the frame 10. The upper end of the extension portion 141 in the Z direction is connected to the connection terminal 140, and the lower end of the extension portion 141 in the Z direction is connected to the electrode connection portion 142. The electrode connection portion 142 extends from the lower end, in the Z direction, of the extension portion 141 in the positive X direction and is connected to the positive-terminal-side terminal electrode 112 in the Z direction. In this way, the positive-terminal-side bus bar 14 connects the positive-terminal-side terminal electrode 112 and the terminal block 12.

A part of the heat of the film capacitor 11 is cooled by the cooling water via a cooling path Rb passing through the positive-terminal-side bus bar 14. The cooling path Rb extends from the positive-terminal-side terminal electrode 112 to the positive-terminal-side connection portion 122 of the terminal block 12 via the positive-terminal-side bus bar 14. The heat of the film capacitor 11 is conducted through the cooling path Rb and diffused from the nuts 92 in the positive-terminal-side connection portion 122 to the flow path 100 in the frame 10 via the silicone sheet 22.

As described above, the positive-terminal-side terminal electrode 112 faces the flow path 100 of the cooling water, and the negative-terminal-side terminal electrode 111 faces the opposite side of the flow path 100. Therefore, in the film capacitor 11, the negative-terminal-side terminal electrode 111 is farther from the flow path 100 than the positive-terminal-side terminal electrode 112. Therefore, in cooling the film capacitor 11 via the silicone sheet 20 at the lower portion of the case 113, the vicinity of the negative-terminal-side terminal electrode 111 of the capacitor element 110 might not obtain a cooling effect as compared with the vicinity of the positive-terminal-side terminal electrode 112.

In contrast, the thermal conductivity between the film capacitor 11 and the flow path 100 for the cooling water is higher in the negative-terminal-side connection portion 121 than in the positive-terminal-side connection portion 122. Therefore, the terminal block 12 has a cooling structure in which the cooling performance of the cooling path Ra is higher than the cooling performance of the cooling path Rb in cooling the film capacitor 11. The vicinity of the negative-terminal-side terminal electrode 111 of the capacitor element 110 is cooled more favorably via the cooling path Ra than the vicinity of the positive-terminal-side terminal electrode 112. Therefore, the cooling effect of the film capacitor 11 is improved. An example of the cooling structure of the terminal block 12 will be described below.

### (Cooling Structure of Terminal Block)

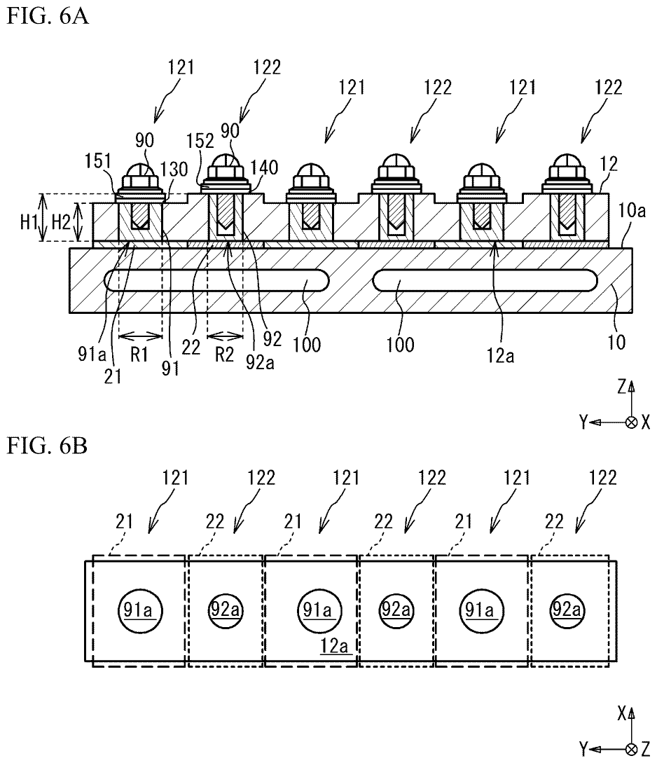

FIG. 6A is a partial cross-sectional view taken along line C-C of FIG. 1. FIG. 6B is a plan view illustrating an example of the lower surface 12a of the terminal block 12 in a front view. In FIG. 6A and FIG. 6B, the same numerals are attached to the configurations common to FIG. 3 and FIG. 5, and the description thereof will be omitted. The terminal block 12 includes first to fourth cooling structures described below.

### [First Cooling Structure]

In the Z direction, a height H2 of the negative electrode side connection portion 121 is lower than a height H1 of the positive-terminal-side connection portion 122. Therefore, the distance from the connection terminal 130 of the negative-terminal-side bus bar 13 to the flow path 100 is shorter than the distance from the connection terminal 140 of the positive-terminal-side bus bar 14 to the flow path 100. As described above, the first cooling structure is a structure in which the connection position between the negative-terminal-side connection portion 121 and the negative-terminal-side bus bar 13 is closer to the flow path 100 than the connection position between the positive-terminal-side connection portion 122 and the positive-terminal-side bus bar 14. Therefore, the cooling performance of the cooling path Ra is higher than the cooling performance of the cooling path Rb, and the thermal conductivity of the negative-terminal-side connection portion 121 is higher than the thermal conductivity of the positive-terminal-side connection portion 122.

### [Second Cooling Structure]

The nuts 91 are embedded in the negative-terminal-side connection portion 121, and the nuts 92 are embedded in the positive-terminal-side connection portion 122. The nuts 91 and 92 are embedded with end surfaces 91a and 92a in axial direction thereof facing the flow path 100, respectively. The negative-terminal-side bus bar 13 is fastened to the nuts 91 by the bolts 90, and the positive-terminal-side bus bar 14 is fastened to the nuts 92 by the bolts 90. The second cooling structure is a structure in which the size of the end surface 91a of the nut 91 is larger than the size of the end surface 92a of the nut 92. For example, the diameter R1 of the nut 91 is larger than the diameter R2 of the nut 92. Thus, the thermal conductivity from the nut 91 to the flow path 100 is higher than the thermal conductivity from the nut 92 to the flow path 100. Therefore, the cooling performance of the cooling path Ra is higher than the cooling performance of the cooling path Rb, and the thermal conductivity of the negative-terminal-side connection portion 121 is higher than the thermal conductivity of the positive-terminal-side connection portion 122. The nut 92 is an example of a first nut, and the nut 91 is an example of a second nut. In addition, in contrast to the present example, when the film capacitor 11 is mounted on the frame 10 with the negative-terminal-side terminal electrode 111 facing the flow path 100 and the positive-terminal-side terminal electrode 112 facing the opposite side, the nut 92 corresponds to the second nut and the nut 91 corresponds to the first nut.

### [Third Cooling Structure]

The third cooling structure is a structure in which the thermal conductivity of the nut 91 is higher than the thermal conductivity of the nut 92. For example, the nut 91 is formed of copper, and the nut 92 is formed of iron. Thus, the thermal conductivity from the nut 91 to the flow path 100 is higher than the thermal conductivity from the nut 92 to the flow path 100. Therefore, the cooling performance of the cooling path Ra is higher than the cooling performance of the cooling path Rb, and the thermal conductivity of the negative-terminal-side connection portion 121 is higher than the thermal conductivity of the positive-terminal-side connection portion 122.

### [Fourth Cooling Structure]

The fourth cooling structure is a structure in which the thermal conductivity of the silicone sheet 21 is higher than the thermal conductivity of the silicone sheet 22. The silicone sheet 21 is sandwiched between the end surface 91a of the nut 91 and the plate surface 10a of the frame 10, and the silicone sheet 22 is sandwiched between the end surface 92a of the nut 92 and the plate surface 10a of the frame 10. The silicone sheets 21 and 22 are made of a resin such as silicon or olefin. Inorganic fillers such as boron nitride and alumina are added to the silicone sheet 21. Thus, the thermal conductivity of the silicone sheet 21 is higher than the thermal conductivity of the silicone sheet 22.

Thus, the thermal conductivity from the nut 91 to the flow path 100 is higher than the thermal conductivity from the nut 92 to the flow path 100. Therefore, the cooling performance of the cooling path Ra is higher than the cooling performance of the cooling path Rb, and the thermal conductivity of the negative-terminal-side connection portion 121 is higher than the thermal conductivity of the positive-terminal-side connection portion 122. The silicone sheet 22 is an example of a first sheet member, and the silicone sheet 21 is an example of a second nut. In contrast to the present example, when the film capacitor 11 is placed on the frame 10 with the negative-terminal-side terminal electrode 111 facing the flow path 100 and the positive-terminal-side terminal electrode 112 facing the opposite side, the silicone sheet 22 corresponds to the second nut, and the silicone sheet 21 corresponds to the first nut.

The terminal block 12 may not include all of the first to fourth cooling structures, and may include at least one of the first to fourth cooling structures. In order to suppress heat generation due to a DC component of a current, the cross-sectional area of the connection terminal 130 of the negative-terminal-side bus bar 13 may be larger than the cross-sectional area of the connection terminal 140 of the positive-terminal-side bus bar 14.

Although some embodiments of the present disclosure have been described in detail, the present disclosure is not limited to the specific embodiments but may be varied or changed within the scope of the present disclosure as claimed.

What is claimed is:

1. A power conversion device comprising:
a capacitor including a first terminal electrode and a second terminal electrode opposed to the first terminal electrode;
a power module including a power semiconductor element;
a terminal block for electrically connecting the capacitor and the power module to each other;
a first bus bar connecting the first terminal electrode and the terminal block;
a second bus bar connecting the second terminal electrode and the terminal block; and
a plate member on which the capacitor, the power module, and the terminal block are mounted, the plate member including a flow path for a cooling medium that cools the capacitor and the terminal block,
wherein
the capacitor is mounted on the plate member with the first terminal electrode facing the flow path and the second terminal electrode facing a side opposite to the flow path, and
the terminal block includes:
a first connection portion connected to the first bus bar; and
a second connection portion connected to the second bus bar,
thermal conductivity between the capacitor and the flow path in the second connection portion is higher than thermal conductivity between the capacitor and the flow path in the first connection portion.

2. The power conversion device according to claim 1, wherein a connection position of the second connection portion and the second bus bar is closer to the flow path than a connection position of the first connection portion and the first bus bar is.

3. The power conversion device according to claim 1, wherein
a first nut to which the first bus bar is fastened by a bolt is embedded in the first connection portion such that an end surface of the first nut faces the flow path in an axial direction of the first nut, and
a second nut to which the second bus bar is fastened by a bolt is embedded in the second connection portion such that an end surface of the second nut faces the flow path in an axial direction of the second nut, and
an area of the end surface of the second nut is larger than an area of the end surface of the first nut.

4. The power conversion device according to claim 1,
a first nut to which the first bus bar is fastened by a bolt is embedded in the first connection portion such that an end surface of the first nut faces the flow path in an axial direction of the first nut,
a second nut to which the second bus bar is fastened by a bolt is embedded in the second connection portion such that an end surface of the second nut faces the flow path in an axial direction of the second nut, and
thermal conductivity of the second nut is higher than thermal conductivity of the first nut.

5. The power conversion device according to claim 1, wherein
a first nut to which the first bus bar is fastened by a bolt is embedded in the first connection portion with an end surface of the first nut facing the flow path in an axial direction of the first nut,
a first sheet member is provided between the end surface of the first nut and a plate surface of the plate member,
a second nut to which the second bus bar is fastened by a bolt is embedded in the second connection portion with an end surface of the second nut facing the flow path in an axial direction of the second nut,
a second sheet member is provided between the end surface of the second nut and a plate surface of the plate member, and
thermal conductivity of the second sheet member is higher than thermal conductivity of the first sheet member.
